(19) United States
(12) Patent Application Publication
(10) Pub. No.: US 2003/0035701 A1
(43) Pub. Date: Feb. 20, 2003

(54) Fastener element capped with aluminum or the like

(76) Inventor: David Hui, Taipei (TW)

Correspondence Address: David Hui, P.O. Box 55-846, Taipei, 104, TW

(21) Appl. No.: 10/214,894

(22) Filed: Aug. 5, 2002

(30) Foreign Application Priority Data
Aug. 17, 2001 (TW) 90214136

(51) Int. Cl. F16B 37/14

(52) U.S. Cl. 411/372.5

(57) ABSTRACT

A fastener element such as a bolt (or a nut) includes: a base portion having a coupling portion such as a male-threaded shank integrally formed with the base portion (or a female-threaded hole formed in the base portion) and a head portion protruding upwardly from the base portion; and a cap member made of aluminum alloy or the like capped on the head portion, with the cap member made as diversified decorative or functional features for selectively capping the head portion of the fastener element.

### BACKGROUND OF THE INVENTION

U.S. Pat. No. 3,983,304 entitled “Fastener with Protective Metal-organic Base Coating” disclosed a fastener provided a protective coating for protection against corrosion and deterioration, formed by application of a mixture of powdered metallic substance with a resin in a solvent, for making a very thin coating thickness.

However, such a prior art has the following drawbacks:

1. The fastener such as a bolt or screw may just be coated with a thin-layer coating (12) on the shank (10) and head (11). Since the coating material is sprayed, dipped or brushed on the body of the fastener merely with a thin layer, the head (11) of the fastener can not be easily modified for varying its three-dimensional shapes or decorative or functional features. For diversifying the shapes of the fastener, especially the fastener head portion, a plurality of molds should be prepared to possibly increase the investment cost.

2. Even the coating material may be selected from light weight materials, the total weight of each fastener may not be substantially reduced or influenced since the coating thickness is very thin.

The present inventor has found the drawbacks of the conventional fasteners and invented the present fastener element capped with aluminum or the like.

### SUMMARY OF THE INVENTION

The object of the present invention is to provide a fastener element such as a bolt (or a nut) including: a base portion having a coupling portion such as a male-threaded shank integrally formed with the base portion (or a female-threaded hole formed in the base portion) and a head portion protruding upwardly from the base portion; and a cap member made of aluminum alloy or the like capped on the head portion, with the cap member made as diversified decorative or functional features for selectively capping the head portion of the fastener element.

### BRIEF DESCRIPTION OF THE DRAWINGS

FIG. 1 is a partial sectional drawing of a bolt in accordance with the present invention.

FIGS. 2A, 2B and 2C show the diversified features of the bolts of the present invention.

FIG. 3 is a partial sectional drawing of a nut in accordance with the present invention.

### DETAILED DESCRIPTION

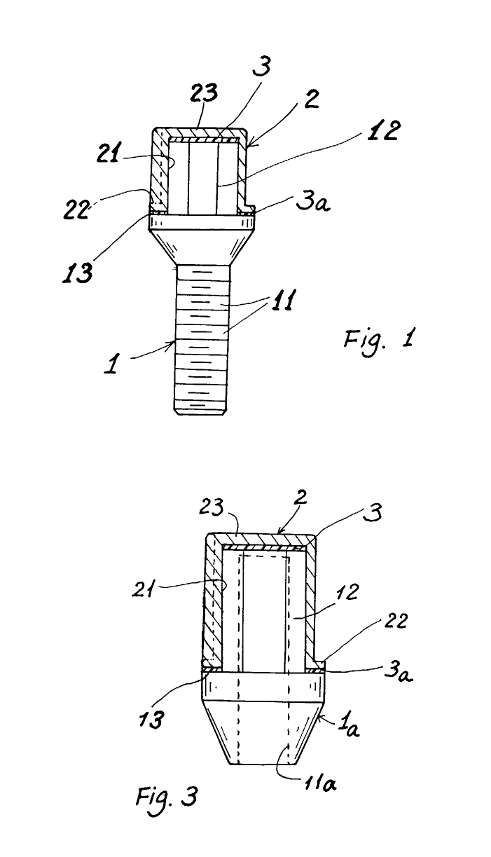

As shown in FIG. 1, the fastener element of the present invention comprises: a bolt 1 and a cap member 2 capped on the bolt 1. The bolt 1 may be made of steel, iron or other metals or alloys. The cap member 2 is preferably made of aluminum alloy.

The fastener element or the bolt 1 includes: a base portion 13; a coupling portion 11 formed with or protruding downwardly from the base portion 13, with the coupling portion 11 formed as a male-threaded shank portion; and a head portion 12 protruding upwardly from the base portion 13.

The head portion 12 may be formed as polygonal shapes including hexagonal or square shapes.

The base portion 13 may be formed as conical shape, a truncated-cone shape, a cylindrical shape or an annular flange between the head portion 12 and the coupling portion 11, not limited in the present invention.

The cap member 2 includes: a socket 21 recessed in the cap member 2 and engaged with the head portion 12 of the fastener element (or bolt) 1, a flange 22 formed on a bottom periphery of the cap member 2 to be engaged with a rim of the base portion 13 of the fastener element 1, and an upper cover 23 formed on an upper portion of the cap member 2. The flange 22 may also be eliminated from the cap member.

The cap member 2 may be joined with the head portion 12 of the fastener element 1 by any mechanical joining methods, such as by press fits, shrink and expansion fits or by adhesive bonding such as the adhesive 3 bonded between the upper cover 23 of the cap member 2 and the top surface of the head portion 12 of the fastener element; and the adhesive 3a bonded between the flange 22 and the base portion 13.

The upper cover 23 and the cap member 2 may be formed as any decorative features, or processed by anodizing to further provide a colorful or corrosion-resistant finish on the surfaces of the upper cover 23 and the cap member 2.

The upper cover 23 of the cap member 2 may be formed as a three-dimensional protrusion 24 on the cover 23 with diversified designs, shapes or features so as to form a “locking device”. For example, the cap member 2 as fixed on the fastener element (bolt) 1, after being formed with protrusion 24 of special design, will become a “wheel lock” which is provided for fixing the tire disc with a hub of a car axle. Then, when an intruder tries to dismantle the tire disc and the tire of a precious car of famous brand provided with the special “wheel lock” as made by the bolt and cap member of the present invention, he will be unable to operate (unlock) the bolts and will fail to steal the tire unless he gets a special wrench or tool matching with the special protrusion 24 of the bolt of the present invention.

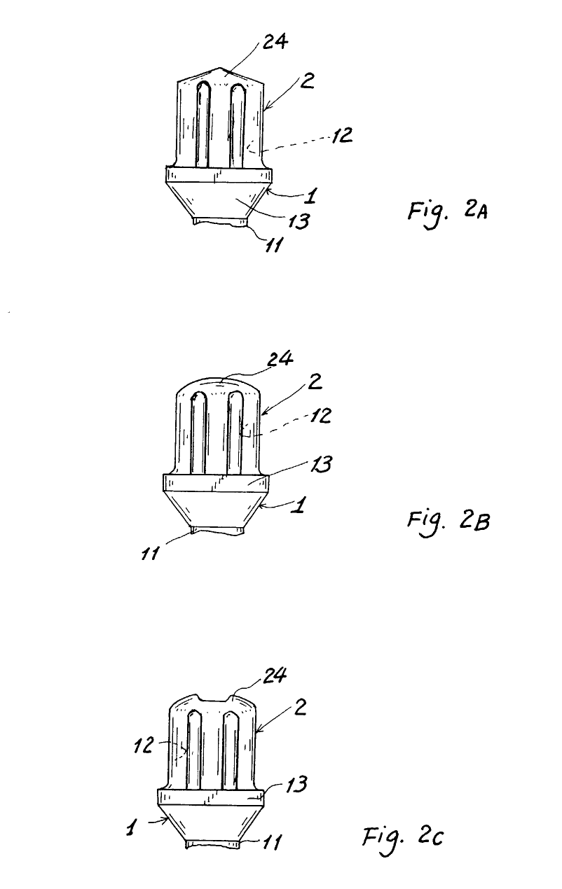

As shown in FIGS. 2A, 2B and 2C, several designs of the cap member 2 are exemplified, illustrating the useful examples of the present invention; but not limited.

So, the present invention also provides a safe locking device for bolt (or nut) besides its decorative features. The present invention may thus have the following advantages superior to any conventional bolt and nut:

1. A plurality of diversified cap members 2 may be optionally selected for capping the bolt for choices.

2. Even the head portion 12 of a steel bolt 1 may be a heavy “core”, the cap member 2 as being made of aluminum alloy is however light in weight so that the total weight of the fastener element can be reduced, while uninfluencing the mechanical strength of the fastener element.

3. A conventional steel bolt 1 may be served as a “core” and a specially-designed cap member 2 of the present invention may be capped on the “core” bolt 1 to form a “special” bolt for safety or decorative meanings.

4. Bi-metal bolt as made in accordance with the present invention may harmonize the properties of aluminum and steel to be economically useful. If the bolt is completely made of aluminum, the bolt strength is too weak. If the bolt is completely made of steel, it is too heavy and also presents with poor decorative color. So, the present invention discloses an externally feature-decorated aluminum cap 2 with an internally strength-reinforced steel bolt 2, thereby effectively harmonizing the raw materials for forming the fastener element.

The aforementioned embodiment is a bolt 1 of a fastener element, while a nut 1a as shown in FIG. 3 and described hereinafter may also be defined as the fastener element of the present invention.

The nut 1a of the fastener element includes: a base portion 13; a coupling portion 11 formed in the base portion 13, with the coupling portion 11a formed as a female-threaded hole; and a head portion 12 protruding upwardly from the base portion 13.

The head portion 12 may be formed as polygonal shapes including hexagonal or square shapes.

The base portion 13 may be formed as conical shape, a truncated-cone shape, a cylindrical shape, an annular flange or other shapes on the base of the head portion 12.

The cap member 2 similar to that as shown in FIG. 1 includes: a socket 21 recessed in the cap member 2 and engaged with the head portion 12 of the nut 1a of the fastener element, a flange 22 formed on a bottom periphery of the cap member 2 to be engaged with a rim of the base portion 13 of the nut 1a, and an upper cover 23 formed on an upper portion of the cap member 2.

The cap member 2 may be joined with the head portion 12 of the nut 1a by any mechanical joining methods, or by adhesive bonding such as the adhesive 3 bonded between the upper cover 23 of the cap member 2 and the top surface of the head portion 12 of the nut 1a; and the adhesive 3a bonded between the flange 22 and the base portion 13.

The upper cover 23 and the cap member 2 may be formed as any decorative features, or processed by anodizing to further provide a colorful or corrosion-resistant finish on the surfaces of the upper cover 23 and the cap member 2.

The upper cover 23 of the cap member 2 may be formed as any three-dimensional protrusion on the cover 23 with diversified designs, shapes or features so as to form a “safety nut” for preventing from being operated by any unexpected person or intruder.

The present invention may be modified without departing from the spirit and scope of the present invention. Besides aluminum alloy, other suitable metals may be chosen for making the cap member 2 for capping the bolt 1 or nut 1a in accordance with the present invention.

I claim:

1. A fastener element comprising:
a steel fastener element including a base portion, a coupling portion formed with said base portion, and a head portion protruding upwardly from said base portion; and
a cap member made of aluminum alloy and engaged with said head portion of said fastener element; whereby upon decoration and forming of three-dimensional shapes for a plurality of said cap members, and upon selection from said plurality of cap members, each said cap member is selectively capped on said head portion of said fastener element.

2. A fastener element according to claim 1, wherein said head portion of said fastener element is formed as polygonal shape and engaged with a socket of polygonal shape recessed in said cap member.

3. A fastener element according to claim 1, wherein said cap member is capped on said head portion of said fastener element by mechanical joining and fastening.

4. A fastener element according to claim 1, wherein said cap member is capped on said fastener element by adhesive as bonded between said cap member and said fastener element.

5. A fastener element according to claim 1, wherein said cap member includes a socket recessed in said cap member and engaged with said head portion of said fastener element, and an upper cover formed on an upper portion of said cap member.

6. A fastener element according to claim 5, wherein said upper cover of said cap member is decorated and formed with a three-dimensional protrusion thereon.

7. A fastener element according to claim 6, wherein said three-dimensional protrusion on said upper cover of said cap member is formed with a shape matching with a shape of a socket recessed in a tool provided for driving said cap member on said fastener member by said tool.

8. A fastener element according to claim 1, wherein said fastener element is a bolt and said coupling portion is a male-threaded shank portion protruding downwardly from said base portion.

9. A fastener element according to claim 1, wherein said fastener element is a nut and said coupling portion is a female-threaded hole formed in said base portion.

10. A fastener element according to claim 1, wherein said cap member includes a bottom flange engaged with a rim of said base portion of said fastener element.

11. A fastener element comprising:
a fastener element including a base portion, a coupling portion formed with said base portion, and a head portion protruding upwardly from said base portion; and
a cap member engaged with said head portion of said fastener element; said cap member having a protrusion formed on an upper portion of said cap member; whereby upon capping of said cap member on said fastener element and upon matching of said protrusion on said cap member with a wrench, said fastener element as capped with said cap member will be operated by said wrench for locking or unlocking the fastener element.
